(19) United States
(12) Patent Application Publication
(10) Pub. No.: US 2016/0330611 A1
(43) Pub. Date: Nov. 10, 2016

(54) METHODS FOR SENDING AND RECEIVING USER DATA AND TERMINAL DEVICES

(71) Applicant: HUAWEI TECHNOLOGIES CO., LTD., Shenzhen, Guangdong (CN)

(72) Inventors: Zijun Li, Shenzhen (CN); Guoqiang Rong, Shenzhen (CN)

(21) Appl. No.: 15/110,671

(22) PCT Filed: Jan. 9, 2014
(86) PCT No.: PCT/CN2014/070414

§ 371 Date: Jul. 8, 2016

(51) Int. Cl. H04W 8/20; H04L 29/08

(52) U.S. Cl. CPC H04W 8/205; H04L 67/1097; H04L 67/1095; H04W 88/02

(57) ABSTRACT

Embodiments of the present invention provide methods for sending and receiving user data and terminal devices, to resolve a problem that user data cannot be transferred together with SIM card data. The method includes: receiving, by a first terminal, an instruction for transferring a virtual subscriber identity module SIM card of the first terminal to a second terminal; acquiring, by the first terminal according to the instruction, user data associated with the virtual SIM card; and sending, by the first terminal, the user data to a server, or sending, by the first terminal, the user data to the second terminal.

### CROSS REFERENCE TO RELATED APPLICATIONS

The present application claims priority under 35 U.S.C. §365 to International Patent Application No. PCT/CN2014/070414 filed Jan. 9, 2014, which is incorporated herein by reference into the present disclosure as if fully set forth herein.

### TECHNICAL FIELD

The present invention relates to the field of communications technologies, and in particular, to methods for sending and receiving user data and terminal devices.

### BACKGROUND

In a subscriber identity module (Subscriber Identity Module, SIM) card of a terminal such as a mobile phone or a third-generation mobile communication (third generation, 3G) WAN card, SIM card data that is necessary for connecting the terminal to a network of a telecommunications operator is recorded, including an international mobile subscriber identity (International Mobile Subscriber identity, IMSI), an authentication key, and a related parameter of the network of the operator. The terminal can implement a communication function only after a SIM card is installed therein.

The SIM card further has some storage space, and the terminal can save some user data in the SIM card, for example, the terminal saves contact information or a short message service message in the SIM card. When the SIM card is inserted into different terminals, the user data can be transferred between different mobile phones. When a user needs to use the user data in the SIM card, the user data can be read from the SIM card by using a relevant program of the terminal.

With the development of technologies, people further propose a solution of a virtual SIM card, that is, the communication function is implemented by downloading SIM card data and saving the SIM card data in a secure storage area of a terminal, and reading data in the area by the terminal using a corresponding management module, without inserting a SIM card in a physical form into the terminal. In this way, use and management of the SIM card data are easier; in addition, because there is no limitation by a SIM card slot, one terminal can be provided with multiple virtual SIM cards.

In the prior art of virtual SIM cards, when a virtual SIM card is transferred between terminals, that is, SIM card data is deleted from a terminal and installed in another terminal, because the virtual SIM card cannot carry user data such as contact information by using its own storage space like a physical SIM card, the user data cannot be transferred together with the SIM card data to the new terminal, and the user can only transfer the user data separately, which is not convenient enough.

### SUMMARY

Embodiments of the present invention provide methods for sending and receiving user data and terminal devices, to resolve a problem that user data cannot be transferred together with SIM card data.

According to a first aspect, an embodiment of the present invention provides a method for sending user data, including:

receiving, by a first terminal, an instruction for transferring a virtual subscriber identity module SIM card of the first terminal to a second terminal;

acquiring, by the first terminal according to the instruction, user data associated with the virtual SIM card; and

sending, by the first terminal, the user data to a server, or sending, by the first terminal, the user data to the second terminal.

With reference to the first aspect, in a first possible implementation manner, the acquiring, by the first terminal according to the instruction, user data associated with the virtual SIM card includes:

acquiring, by the first terminal, SIM card data of the virtual SIM card according to the instruction;

acquiring, by the first terminal, a local storage address of the user data, where the local storage address of the user data is included in the SIM card data; and

acquiring, by the first terminal, the user data according to the local storage address.

With reference to the first possible implementation manner of the first aspect, in a second possible implementation manner, the sending, by the first terminal, the user data to a server includes:

acquiring, by the first terminal, a network storage address of the user data, where the network storage address of the user data is included in the SIM card data; and

uploading, by the first terminal, the user data to a server that corresponds to the network storage address.

With reference to the first aspect, in a third possible implementation manner, the method further includes:

sending, by the first terminal, an owner identifier of the user data to the server when sending the user data to the server, so that the server sends the user data to the second terminal when receiving a request for downloading the user data, where the request is sent by the second terminal and carries the owner identifier.

With reference to the first aspect, in a fourth possible implementation manner, the acquiring, by the first terminal according to the instruction, user data associated with the virtual SIM card includes:

acquiring, by the first terminal, SIM card data of the virtual SIM card according to the instruction, where the SIM card data includes the user data; and

the sending, by the first terminal, the user data to a server, or sending, by the first terminal, the user data to the second terminal includes:

sending, by the first terminal, the SIM card data to the server, or sending, by the first terminal, the SIM card data to the second terminal.

With reference to the first aspect or any one of the first to fourth possible implementation manners of the first aspect, in a fifth possible implementation manner, the user data includes one or any combination of the following types of data:

contact information, short message service message, text document, image data, video data and audio data.

According to a second aspect, an embodiment of the present invention provides a method for receiving user data, including:

receiving, by a second terminal, an instruction for transferring a virtual subscriber identity module SIM card of a first terminal to the second terminal; and

receiving, by the second terminal according to the instruction, user data that is sent by a server and associated with the virtual SIM card; or receiving, by the second terminal according to the instruction, user data that is sent by the first terminal and associated with the virtual SIM card.

With reference to the second aspect, in a first possible implementation manner, the receiving, by the second terminal according to the instruction, user data that is sent by a server and associated with the virtual SIM card includes:

receiving, by the second terminal, SIM card data of the virtual SIM card according to the instruction, where the SIM card data of the virtual SIM card is sent by the first terminal;

acquiring, by the second terminal, a network storage address of the user data, where the network storage address of the user data is included in the SIM card data;

requesting, by the second terminal, a server that corresponds to the network storage address to send the user data; and receiving, by the second terminal, the user data sent by the server.

With reference to the first possible implementation manner of the second aspect, in a second possible implementation manner, after the receiving, by the second terminal, the user data sent by the server, the method further includes:

acquiring, by the second terminal, a local storage address of the user data; and

recording, by the second terminal, the local storage address in the SIM card data.

According to a third aspect, an embodiment of the present invention provides a terminal device, where the terminal device includes:

an instruction receiving unit, configured to receive an instruction for transferring a virtual SIM card to another terminal;

a data acquiring unit, configured to acquire, according to the instruction, user data associated with the virtual SIM card; and a data output unit, configured to send the user data to a server, or send the user data to the another terminal.

With reference to the third aspect, in a first possible implementation manner, the data acquiring unit is specifically configured to:

acquire SIM card data of the virtual SIM card according to the instruction;

acquire a local storage address of the user data, where the local storage address of the user data is included in the SIM card data; and

acquire the user data according to the local storage address.

With reference to the first possible implementation manner of the third aspect, in a second possible implementation manner, the data acquiring unit is specifically configured to acquire a network storage address of the user data, where the network storage address of the user data is included in the SIM card data; and the data output unit is specifically configured to upload the user data to a server that corresponds to the network storage address.

With reference to the third aspect, in a third possible implementation manner, the data output unit is further configured to:

send an owner identifier of the user data to the server, so that the server sends the user data to the another terminal when receiving a request for downloading the user data, where the request is sent by the another terminal and carries the owner identifier.

With reference to the third aspect, in a fourth possible implementation manner, the data acquiring unit is specifically configured to:

acquire SIM card data of the virtual SIM card according to the instruction, where the SIM card data includes the user data; and

the data output unit is specifically configured to:

send the SIM card data to the server, or send the SIM card data to the another terminal.

According to a fourth aspect, an embodiment of the present invention provides a terminal device, where the terminal device includes:

an instruction receiving unit, configured to receive an instruction for transferring a virtual subscriber identity module SIM card of another terminal to the terminal; and

a first data receiving unit, configured to receive, according to the instruction, user data that is sent by a server and associated with the virtual SIM card, and/or a second data receiving unit, configured to receive, according to the instruction, user data that is sent by the another terminal and associated with the virtual SIM card.

With reference to the fourth aspect, in a first possible implementation manner, the first data receiving unit is specifically configured to:

receive SIM card data of the virtual SIM card according to the instruction, where the SIM card data of the virtual SIM card is sent by the another terminal;

acquire a network storage address of the user data, where the network storage address of the user data is included in the SIM card data;

request a server that corresponds to the network storage address to send the user data; and

receive the user data sent by the server.

With reference to the first possible implementation manner of the fourth aspect, in a second possible implementation manner, the terminal device further includes:

a local recording unit, configured to: after the first data receiving unit receives the user data sent by the server, acquire a local storage address of the user data; and

record the local storage address in the SIM card data.

According to a fifth aspect, an embodiment of the present invention provides a terminal device, where the terminal device includes:

a memory, configured to store user data associated with a virtual SIM card;

a processor, configured to receive an instruction for transferring the virtual SIM card to another terminal, and acquire the user data according to the instruction; and

a transmitter, configured to send the user data to a server, or send the user data to the another terminal.

With reference to the fifth aspect, in a first possible implementation manner, the memory is further configured to store SIM card data of the virtual SIM card; and

the processor being configured to acquire the user data according to the instruction specifically includes:

acquiring the SIM card data according to the instruction;

acquiring a local storage address of the user data, where the local storage address of the user data is included in the SIM card data; and

acquiring the user data according to the local storage address.

With reference to the first possible implementation manner of the fifth aspect, in a second possible implementation manner,

the processor is further configured to: acquire a network storage address of the user data, where the network storage address of the user data is included in the SIM card data; and

the transmitter is specifically configured to: upload the user data to a server that corresponds to the network storage address.

With reference to the fifth aspect, in a third possible implementation manner, the transmitter is further configured to: send an owner identifier of the user data to the server, so that the server sends the user data to the another terminal when receiving a request for downloading the user data, where the request is sent by the another terminal and carries the owner identifier.

With reference to the fifth aspect, in a fourth possible implementation manner, the memory is further configured to store SIM card data of the virtual SIM card; and

the processor being configured to acquire the user data according to the instruction specifically includes:

acquiring the SIM card data according to the instruction, where the SIM card data includes the user data; and

the transmitter is specifically configured to:

send the SIM card data to the server, or send the SIM card data to the another terminal.

According to a sixth aspect, an embodiment of the present invention provides a terminal device, where the terminal device includes:

a processor, configured to receive an instruction for transferring a virtual subscriber identity module SIM card of another terminal to the terminal;

a transceiver, configured to receive, according to the instruction, user data that is sent by a server and associated with the virtual SIM card, or receive, according to the instruction, user data that is sent by the another terminal and associated with the virtual SIM card; and

a memory, configured to store the user data.

With reference to the sixth aspect, in a first possible implementation manner, the transceiver being configured to receive, according to the instruction, user data that is sent by a server and associated with the virtual SIM card specifically includes:

receiving SIM card data of the virtual SIM card according to the instruction, where the SIM card data of the virtual SIM card is sent by the another terminal;

requesting a server that corresponds to a network storage address of the user data to send the user data, where the network storage address of the user data is included in the SIM card data; and

receiving the user data sent by the server.

With reference to the first possible implementation manner of the sixth aspect, in a second possible implementation manner, the memory is further configured to:

after the transceiver receives the SIM card data of the virtual SIM card, store the SIM card data, where the SIM card data of the virtual SIM card is sent by the another terminal; and

the processor is further configured to:

after the transceiver receives the user data sent by the server, acquire a local storage address of the user data; and

record the local storage address in the SIM card data stored in the memory.

In the embodiments of the present invention, a first terminal receives an instruction for transferring a virtual subscriber identity module SIM card of the first terminal to a second terminal, the first terminal acquires, according to the instruction, user data associated with the virtual SIM card, and the first terminal sends the user data to a server, or the first terminal sends the user data to the second terminal, so that when the first terminal transfers the virtual SIM card to the second terminal, the second terminal acquires the user data associated with the virtual SIM card, thereby avoiding separately transferring the user data by a user, reducing processing steps of the user, and providing more convenience.

### BRIEF DESCRIPTION OF THE DRAWINGS

FIG. 1 is a schematic flowchart of a method for sending user data according to an embodiment of the present invention;

FIG. 2 is a schematic diagram of information about user data storage addresses according to an embodiment of the present invention;

FIG. 3 is a schematic flowchart of a method for receiving user data according to an embodiment of the present invention;

FIG. 4 and FIG. 5 are schematic flowcharts according to specific Embodiment 1 of the present invention;

FIG. 6 is a schematic flowchart according to specific Embodiment 2 of the present invention; and

FIG. 7 to FIG. 1.0 are schematic structural diagrams of terminal devices according to embodiments of the present invention.

### DETAILED DESCRIPTION

Embodiments of the present invention provide methods for sending and receiving user data and terminal devices, which are used to achieve that when a virtual SIM card is transferred between terminals, a terminal receiving the virtual SIM card can acquire user data associated with the virtual SIM card, thereby reducing processing steps of a user, and providing more convenience.

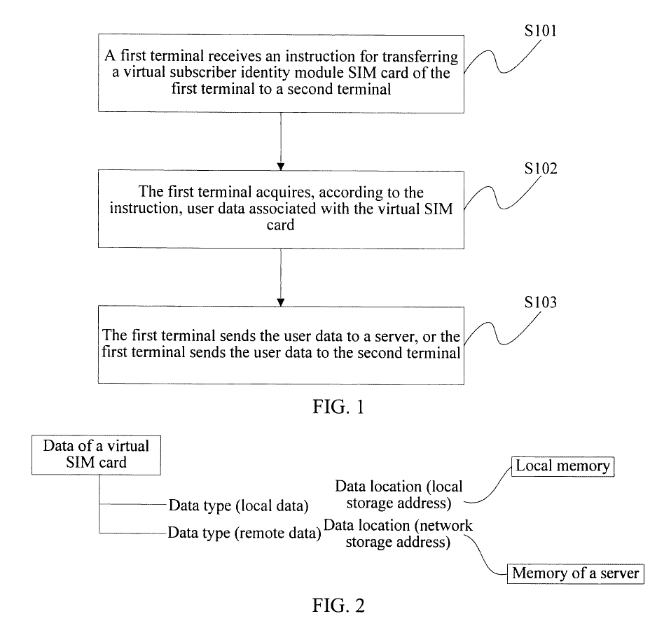

Referring to FIG. 1, a method for sending user data provided in an embodiment of the present invention includes:

S101: A first terminal receives an instruction for transferring a virtual subscriber identity module SIM card of the first terminal to a second terminal.

S102: The first terminal acquires, according to the instruction, user data associated with the virtual SIM card.

S103: The first terminal sends the user data to a server, or the first terminal sends the user data to the second terminal.

In this embodiment of the present invention, a user associates, in the following two manners in advance, the virtual SIM card with the user data that needs to be transferred together with the virtual SIM card: One manner is reserving some storage space in SIM card data of the virtual SIM card, so that the user directly writes, deletes, modifies and queries for user data in the reserved storage space by using a management module. The other manner is newly adding address information of local storage space to SIM card data, where all user data of the user that needs to be transferred together with the virtual SIM card is stored in this local storage space, and the user can perform operations such as user data writing, deletion, modification and query in this local storage space. The management module is a module between an application program and the virtual SIM card, providing an application programming interface (Application Program Interface, API) for invocation by the application program. Any operation on the SIM card data can only be performed by using the management module.

Optionally, the acquiring, by the first terminal according to the instruction, user data associated with the virtual SIM card includes: acquiring, by the first terminal, SIM card data of the virtual SIM card according to the instruction, where the SIM card data includes the user data; and the sending, by the first terminal, the user data to a server, or sending, by the first terminal, the user data to the second terminal includes: sending, by the first terminal, the SIM card data to the server, or sending, by the first terminal, the SIM card data to the second terminal.

Optionally, the acquiring, by the first terminal according to the instruction, user data associated with the virtual SIM card includes: acquiring, by the first terminal, SIM card data of the virtual SIM card according to the instruction; acquiring, by the first terminal, a local storage address of the user data, where the local storage address of the user data is included in the SIM card data; and acquiring, by the first terminal, the user data according to the local storage address.

Further, after the first terminal acquires the user data according to the local storage address, the sending, by the first terminal, the user data to a server includes: acquiring, by the first terminal, a network storage address of the user data, where the network storage address of the user data is included in the SIM card data; and uploading, by the first terminal, the user data to a server that corresponds to the network storage address, so that the server forwards the user data to the second terminal. The SIM card data not only includes the local storage address of the user data so that the user data is saved by using larger local storage space, but also includes the network storage address of the user data so that network storage space is used for transition when the data is transferred to the second terminal. As shown in FIG. 2, two sets of address information are recorded in the SIM card data, and each set of address information includes two subitems: a data type and a data location. The data type includes local data and remote data, where the local data indicates that data is saved in local persistent storage space of a terminal, such as a secure digital (Secure Digital, SD) card or a hard disk; and the remote data indicates that data is saved in a server on a network side. Correspondingly, the data location includes a local storage address and a network storage address. After being uploaded to the server that corresponds to the network storage address, the user data of the first terminal becomes remote data; and the second terminal sends a request to the server according to the network storage address in the received SIM card data, downloads the remote data from the server, and overwrites the local storage address that is originally recorded in the data of the virtual SIM card with a local storage address of the remote data.

Specifically, by using an XML format as an example, a manner of recording storage addresses of Local Contact (local data) and RemoteContact (remote data) in the SIM card data is as follows:

```
    <?xml version=“1.0” encoding=“UTF-8”?>
    <Data>
    <LocalContact>./device/rockchip/rk30sdk/contract.dat</local
Contact> //a file path of local data
    <RemoteContact>http://www.a.com/contract/userid
</RemoteContact> //a URI of remote data
    <Data>
```

Preferably, because the server may provide services of user data transfer simultaneously for multiple terminals, in order to enable the server to accurately forward the user data of the first terminal to the second terminal, the first terminal sends an owner identifier of the user data to the server when sending the user data to the server, so that when receiving a request for downloading the user data, where the request is sent by the second terminal and carries the owner identifier, the server finds, according to the owner identifier carried in the request, the user data uploaded by the first terminal and sends the user data to the second terminal.

The owner identifier may be an identifier of the virtual SIM card, or a mobile number included in the SIM card data, or other specified information.

Specifically, the sending, by the first terminal, the SIM card data to the second terminal includes: sending, by the first terminal, the SIM card data to the second terminal by using a detachable storage medium or performing near field communication. For example, an SD card, Bluetooth, near field communication (Near Field Communication, NFC), or other manners may be used for transmission. The sending, by the first terminal, the user data to the second terminal may also be implemented in one of these manners in addition to using a server.

Specifically, the user data includes one or any combination of the following types of data: contact information, short message service message, text document, image data, video data and audio data. User data associated with a virtual SIM card is saved by using storage space of a terminal, where the storage space has a relatively large storage capacity. Compared with a physical SIM card that can only carry a small quantity of contact information and short message service messages, this embodiment of the present invention can achieve that the virtual SIM card carries a larger quantity of data in richer formats.

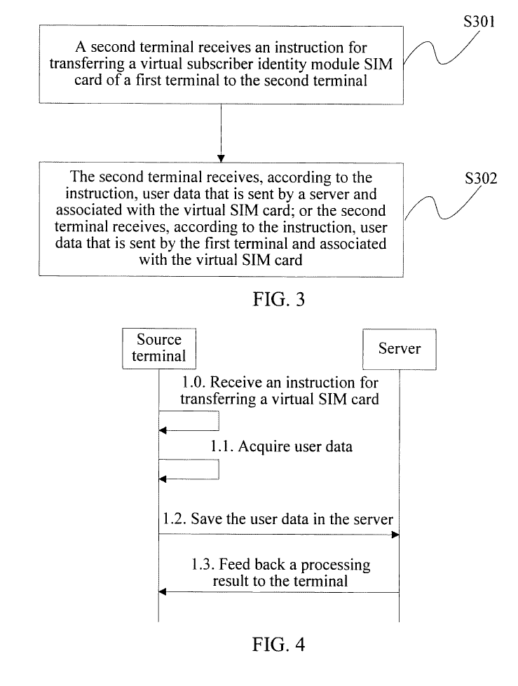

Referring to FIG. 3, a method for receiving user data provided in an embodiment of the present invention includes:

S301: A second terminal receives an instruction for transferring a virtual subscriber identity module SIM card of a first terminal to the second terminal.

302: The second terminal receives, according to the instruction, user data that is sent by a server and associated with the virtual SIM card; or the second terminal receives, according to the instruction, user data that is sent by the first terminal and associated with the virtual SIM card.

Specifically, in step S302, the receiving, by the second terminal according to the instruction, user data that is sent by a server and associated with the virtual SIM card includes: receiving, by the second terminal, SIM card data of the virtual SIM card according to the instruction, where the SIM card data of the virtual SIM card is sent by the first terminal; acquiring, by the second terminal, a network storage address of the user data, where the network storage address of the user data is included in the SIM card data; requesting, by the second terminal, a server that corresponds to the network storage address to send the user data; and receiving, by the second terminal, the user data sent by the server.

Further, after the receiving, by the second terminal, the user data sent by the server, the method further includes: acquiring, by the second terminal, a local storage address of the user data; and recording, by the second terminal, the local storage address in the SIM card data.

The following are specific embodiments of the present invention.

### Specific Embodiment 1

User data is transferred between terminals by using a server. As shown in FIG. 4, on a source terminal side from which a virtual SIM card is transferred, an uploading process of user data includes:

1.0. A terminal receives an instruction for transferring a virtual SIM card.

In actual application, transferring a virtual SIM card from a terminal to another terminal cannot be implemented by simply copying data of the virtual SIM card, but needs to be implemented by using a management module, where the management module acquires a local storage address and a network storage address from the SIM card data.

1.1 The terminal acquires user data.

User data associated with the virtual SIM card is acquired according to the local storage address.

1.2. The terminal saves the user data in a server.

The management module sends a request to the server according to the network storage address, where the request carries an owner identifier of the user data associated with the virtual SIM card, and then sends the user data that corresponds to the local storage address to the server. Before the request message is sent, the server possibly needs to authenticate the management module, to determine whether the management module is legal as a requester.

1.3. The server processes the user data and feeds back a processing result to the terminal.

The server saves the received user data in a memory, and records a correspondence between the user data and the owner identifier of the user data, for convenience of use in a future query. After processing is completed, the server returns a processing result to the terminal.

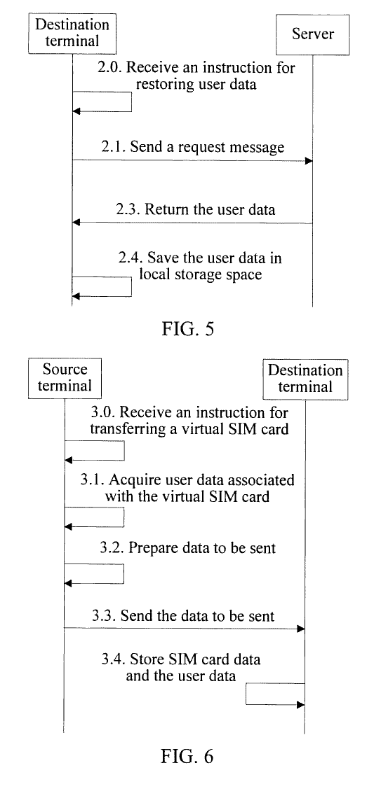

As shown in FIG. 5, on a destination terminal side that receives the virtual SIM card, a downloading process of the user data includes:

2.0. A terminal receives an instruction for restoring the user data.

The data of the virtual SIM card is transferred from the source terminal to the destination terminal by multiple means, for example, SD card copying, Bluetooth transmission, NFC transmission, network backup/restoration, and the like. After completing work of activating the virtual SIM card, a management module receives an instruction for restoring the user data and starts to restore the user data.

2.1. Send a request message to the server.

The management module sends a request to the server for acquiring the user data, where the request carries an owner identifier of the user data. Before the request, the management module may need to be authenticated by the server, to determine whether the management module is legal as a requester.

2.2. The server returns the user data.

The server finds corresponding user data according to the received owner identifier of the user data, and returns the user data.

2.3. The terminal saves the user data in local storage space.

After receiving the user data returned by the server, the management module saves the user data in a local memory. A saving location is determined according to an actual status of the local memory (a space size, including an SD card or not, and the like), and the local storage address in the data of the virtual SIM card is updated after the saving is completed successfully.

### Specific Embodiment 2

User data is directly transmitted between terminals. As shown in FIG. 6, a process includes:

3.0. A management module of a source terminal receives an instruction for transferring a virtual SIM card.

3.1. The management module of the source terminal acquires user data associated with the virtual SIM card.

The management module of the source terminal acquires a local storage address of the user data from SIM card data, and reads the user data from the address.

3.2. The management module of the source terminal prepares data to be sent.

Content of the user data and the SIM card data are put into the data to be transmitted, or formed into a file that can be persistently stored, or temporarily stored in memory.

3.3. The source terminal sends the data to be sent.

A secure connection is established between the source terminal and a destination terminal. A wireless or wired communication mode may be used to establish a data transmission channel, and after mutual authentication between the source terminal and the destination terminal succeeds, the source terminal sends the data to be transmitted, that is, the SIM card data and the user data, to the destination mobile terminal.

3.4. The destination terminal stores SIM card data and the user data.

A management module of the destination terminal parses received information, saves the SIM card data at a corresponding location and saves the user data in a local memory, and updates the local storage address recorded in the data of the virtual SIM card.

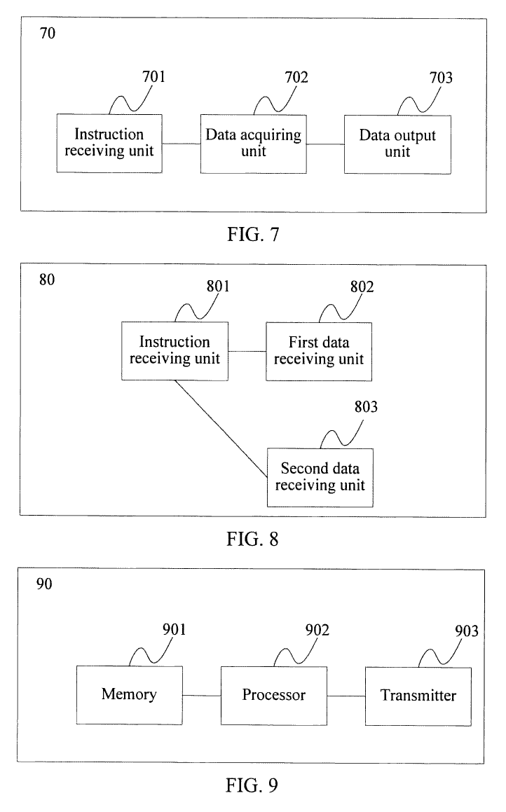

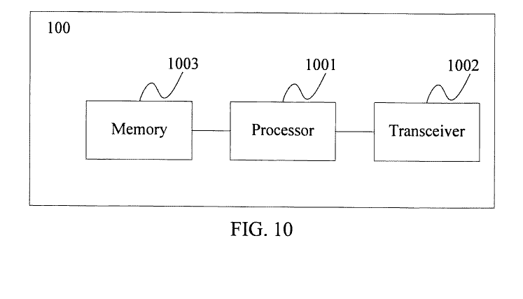

Referring to FIG. 7, a terminal device 70 provided in an embodiment of the present invention includes:

an instruction receiving unit 701, configured to receive an instruction for transferring a virtual SIM card to another terminal;

a data acquiring unit 702, configured to acquire, according to the instruction, user data associated with the virtual SIM card; and

a data output unit 703, configured to send the user data to a server, or send the user data to the another terminal.

Optionally, the data acquiring unit 702 is specifically configured to: acquire SIM card data of the virtual SIM card according to the instruction, where the SIM card data includes the user data; and the data output unit 703 is specifically configured to: send the SIM card data to the server, or send the SIM card data to the another terminal.

Optionally, the data acquiring unit 702 is specifically configured to: acquire SIM card data of the virtual SIM card according to the instruction; acquire a local storage address of the user data, where the local storage address of the user data is included in the SIM card data; and acquire the user data according to the local storage address.

Further, the data acquiring unit 702 is specifically configured to: acquire a network storage address of the user data, where the network storage address of the user data is included in the SIM card data; and the data output unit 703 is specifically configured to: upload the user data to a server that corresponds to the network storage address.

Further, the data output unit 703 is further configured to: send an owner identifier of the user data to the server, so that the server sends the user data to the another terminal when receiving a request for downloading the user data, where the request is sent by the another terminal and carries the owner identifier.

Specifically, the user data includes one or any combination of the following types of data: contact information, short message service message, text document, image data, video data and audio data.

It should be noted that, the terminal device in this embodiment is used to implement the foregoing steps S101 to S103, and the foregoing explanations and limitations for the method are also applicable to the terminal device in this embodiment.

Referring to FIG. 8, a terminal device 80 provided in an embodiment of the present invention includes:

an instruction receiving unit 801, configured to receive an instruction for transferring a virtual subscriber identity module SIM card of another terminal to the terminal; and

a first data receiving unit 802, configured to receive, according to the instruction, user data that is sent by a server and associated with the virtual SIM card, and/or a second data receiving unit 803, configured to receive, according to the instruction, user data that is sent by the another terminal and associated with the virtual SIM card.

The first data receiving unit 802 is specifically configured to:

receive SIM card data of the virtual SIM card according to the instruction, where the SIM card data of the virtual SIM card is sent by the another terminal;

acquire a network storage address of the user data, where the network storage address of the user data is included in the SIM card data;

request a server that corresponds to the network storage address to send the user data; and

receive the user data sent by the server.

Further, the terminal device 80 further includes:

a local recording unit, configured to: after the first data receiving unit receives the user data sent by the server, acquire a local storage address of the user data; and

record the local storage address in the SIM card data.

Referring to FIG. 9, a terminal device 90 provided in an embodiment of the present invention includes:

a memory 901, configured to store user data associated with a virtual SIM card;

a processor 902, configured to receive an instruction for transferring the virtual SIM card to another terminal, and acquire the user data according to the instruction; and

a transmitter 903, configured to send the user data to a server, or send the user data to the another terminal.

Optionally, the memory 901 is further configured to store SIM card data of the virtual SIM card; the processor 902 being configured to acquire the user data according to the instruction specifically includes: acquiring the SIM card data according to the instruction, where the SIM card data includes the user data; and the transmitter 903 is specifically configured to: send the SIM card data to the server, or send the SIM card data to the another terminal.

Optionally, the memory 901 is further configured to store SIM card data of the virtual SIM card; and the processor 902 being configured to acquire the user data according to the instruction specifically includes: acquiring the SIM card data according to the instruction; acquiring a local storage address of the user data, where the local storage address of the user data is included in the SIM card data; and acquiring the user data according to the local storage address.

Further, the processor 902 is further configured to: acquire a network storage address of the user data, where the network storage address of the user data is included in the SIM card data; and the transmitter 903 is specifically configured to: upload the user data to a server that corresponds to the network storage address.

Further, the transmitter 903 is further configured to: send an owner identifier of the user data to the server, so that the server sends the user data to the another terminal when receiving a request for downloading the user data, where the request is sent by the another terminal and carries the owner identifier.

Specifically, the user data includes one or any combination of the following types of data: contact information, short message service message, text document, image data, video data and audio data.

Referring to FIG. 10, a terminal device 100 provided in an embodiment of the present invention includes:

a processor 1001, configured to receive an instruction for transferring a virtual subscriber identity module SIM card of another terminal to the terminal;

a transceiver 1002, configured to receive, according to the instruction, user data that is sent by a server and associated with the virtual SIM card, or receive, according to the instruction, user data that is sent by the another terminal and associated with the virtual SIM card; and

a memory 1003, configured to store the user data.

The transceiver 1002 being configured to receive, according to the instruction, user data that is sent by a server and associated with the virtual SIM card specifically includes: receiving SIM card data of the virtual SIM card according to the instruction, where the SIM card data of the virtual SIM card is sent by the another terminal; requesting a server that corresponds to a network storage address of the user data to send the user data, where the network storage address of the user data is included in the SIM card data: and receiving the user data sent by the server.

The memory 1003 is further configured to: after the transceiver receives the SIM card data of the virtual SIM card, store the SIM card data, where the SIM card data of the virtual SIM card is sent by the another terminal; and the processor 1001 is further configured to: after the transceiver receives the user data sent by the server, acquire a local storage address of the user data, and record the local storage address in the SIM card data stored in the memory.

In conclusion, the embodiments of the present invention provide methods for sending and receiving user data and terminal devices, which achieve that when a virtual SIM card is transferred between terminals, user data associated with the virtual SIM card is transferred, thereby avoiding separately transferring the user data by a user, reducing processing steps of the user, and providing more convenience.

A person skilled in the art should understand that the embodiments of the present invention may be provided as a method, a system, or a computer program product. Therefore, the present invention may use a form of hardware only embodiments, software only embodiments, or embodiments with a combination of software and hardware. Moreover, the present invention may use a form of a computer program product that is implemented on one or more computer-usable storage media (including but not limited to a magnetic disk storage, an optical storage, and the like) that include computer-usable program code.

The present invention is described with reference to the flowcharts and/or block diagrams of the method, the device (system), and the computer program product according to the embodiments of the present invention. It should be understood that computer program instructions may be used to implement each process and/or each block in the flowcharts and/or the block diagrams and a combination of a process and/or a block in the flowcharts and/or the block diagrams.

These computer program instructions may be provided for a general-purpose computer, a dedicated computer, an embedded processor, or a processor of any other programmable data processing de vice to generate a machine, so that the instructions executed by a computer or a processor of any other programmable data processing device generate an apparatus for implementing a specific function in one or more processes in the flowcharts and/or in one or more blocks in the block diagrams.

These computer program instructions may also be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Obviously, a person skilled in the art can make various modifications and variations to the present invention without departing from the spirit and scope of the present invention. The present invention is intended to cover these modifications and variations provided that they fail within the scope of protection defined by the following claims and their equivalent technologies.

1. A method for sending user data, comprising:
receiving, by a first terminal, an instruction for transferring a virtual subscriber identity module (SIM) card of the first terminal to a second terminal;
acquiring, by the first terminal according to the instruction, user data associated with the virtual SIM card; and
sending, by the first terminal, the user data to a server, or sending, by the first terminal, the user data to the second terminal.

2. The method according to claim 1, wherein the acquiring, by the first terminal according to the instruction, user data associated with the virtual SIM card comprises:
acquiring, by the first terminal, SIM card data of the virtual SIM card according to the instruction;
acquiring, by the first terminal, a local storage address of the user data, wherein the local storage address of the user data is comprised in the SIM card data; and
acquiring, by the first terminal, the user data according to the local storage address.

3. The method according to claim 2, wherein the sending, by the first terminal, the user data to a server comprises:
acquiring, by the first terminal, a network storage address of the user data, wherein the network storage address of the user data is comprised in the SIM card data; and
uploading, by the first terminal, the user data to a server that corresponds to the network storage address.

4. The method according to claim 1, further comprising:
sending, by the first terminal, an owner identifier of the user data to the server when sending the user data to the server, so that the server sends the user data to the second terminal when receiving a request for downloading the user data, wherein the request is sent by the second terminal and carries the owner identifier.

5. The method according to claim 1, wherein:
acquiring, by the first terminal according to the instruction, user data associated with the virtual SIM card comprises:
acquiring, by the first terminal, SIM card data of the virtual SIM card according to the instruction, wherein the SIM card data comprises the user data; and
sending, by the first terminal, the user data to a server, or sending, by the first terminal, the user data to the second terminal comprises:
sending, by the first terminal, the SIM card data to the server, or sending, by the first terminal, the SIM card data to the second terminal.

6. The method according to claim 1, wherein the user data comprises one or any combination of the following types of data:
contact information, short message service message, text document, image data, video data and audio data.

7. A method for receiving user data, comprising:
receiving, by a second terminal, an instruction for transferring a virtual subscriber identity module (SIM) card of a first terminal to the second terminal; and
receiving, by the second terminal according to the instruction, user data that is sent by a server and associated with the virtual SIM card; or receiving, by the second terminal according to the instruction, user data that is sent by the first terminal and associated with the virtual SIM card.

8. The method according to claim 7, wherein receiving, by the second terminal according to the instruction, user data that is sent by a server and associated with the virtual SIM card comprises:
receiving, by the second terminal, SIM card data of the virtual SIM card according to the instruction, wherein the SIM card data of the virtual SIM card is sent by the first terminal;
acquiring, by the second terminal, a network storage address of the user data, wherein the network storage address of the user data is comprised in the SIM card data;
requesting, by the second terminal, a server that corresponds to the network storage address to send the user data; and
receiving, by the second terminal, the user data sent by the server.

9. The method according to claim 8, after the receiving, by the second terminal, the user data sent by the server, the method further comprises:
acquiring, by the second terminal, a local storage address of the user data; and
recording, by the second terminal, the local storage address in the SIM card data.

10-17. (canceled)

18. A terminal device, comprising:
a memory, configured to store user data associated with a virtual subscriber identity module (SIM) card;
a processor, configured to receive an instruction for transferring the virtual SIM card to another terminal, and acquire the user data according to the instruction; and
a transmitter, configured to send the user data to a server, or send the user data to the another terminal.

19. The device according to claim 18, wherein:
the memory is further configured to store SIM card data of the virtual SIM card; and
the processor is further configured to:
acquire the SIM card data according to the instruction;
acquire a local storage address of the user data, wherein the local storage address of the user data is comprised in the SIM card data; and
acquire the user data according to the local storage address.

20. The device according to claim 19, wherein:
the processor is further configured to acquire a network storage address of the user data, wherein the network storage address of the user data is comprised in the SIM card data; and
the transmitter is configured to upload the user data to a server that corresponds to the network storage address.

21. The device according to claim 18, wherein the transmitter is further configured to:
send an owner identifier of the user data to the server, so that the server sends the user data to the another terminal when receiving a request for downloading the user data, wherein the request is sent by the another terminal and carries the owner identifier.

22. The device according to claim 18, wherein:
the memory is further configured to store SIM card data of the virtual SIM card;
the processor is further configured to acquire the SIM card data according to the instruction, wherein the SIM card data comprises the user data; and
the transmitter is further configured to send the SIM card data to the server, or send the SIM card data to the another terminal.

23-25. (canceled)
